(19) United States
(12) Patent Application Publication
(10) Pub. No.: US 2015/0053833 A1
(43) Pub. Date: Feb. 26, 2015

(54) PAN-TILT MOUNT SYSTEM FOR IMAGE SENSOR

(71) Applicant: Matthew St. Louis, Austin, TX (US)

(72) Inventor: Matthew St. Louis, Austin, TX (US)

(21) Appl. No.: 13/973,731

(22) Filed: Aug. 22, 2013

(51) Int. Cl. G03B 17/56; B64D 47/08; F16M 13/02

(52) U.S. Cl. CPC G03B 17/561; F16M 13/02; B64D 47/08
USPC 248/278.1

(57) ABSTRACT

An image sensor mount includes a base, a pannable housing coupled to the base, a tiltable housing coupled to the pannable housing, a pan drive that rotates the pannable housing, a tilt drive that rotates the tiltable housing, and an image sensor mount coupled to the tiltable housing. A pannable housing shell and a tiltable housing shell combine to form an enclosure for one of more of the pan drive and the tilt drive.

### BACKGROUND

1. Field

The present invention relates to the field of systems and methods for mounting and positioning image sensors, such as cameras. More particularly, the invention relates to systems and methods of mounting and positioning image sensors on aerial vehicles, such as airplanes.

2. Description of the Related Art

Cameras are sometimes mounted on aircraft to capture video or still images the aircraft's surroundings. Video or still images captured by an airborne camera may be used, for example, for surveillance, reconnaissance, testing, mapping, or information services.

In some cases, airborne cameras are mounted on the fuselage of an aircraft using a mechanism that that can be operated to control the direction of the camera. The mechanism may, for example, point the camera straight down, forward, aft, port, or starboard at various angles of inclination. During flight, the camera and components of the orientation control mechanisms may encounter severe structural loads (for example, vibration, acceleration, and shock) that adversely affect operation or stability of the camera or the orientation control mechanism. In addition, the camera and orientation control mechanism may encounter other environmental conditions, such as moisture, ice, dust, or other contaminants that can adversely affect operation or performance of the camera or orientation mechanism.

### SUMMARY

Systems and methods for mounting and positioning image sensors are described. In an embodiment, an image sensor mount includes a base, a pannable housing coupled to the base, a tiltable housing coupled to the pannable housing, a pan drive that rotates the pannable housing, a tilt drive that rotates the tiltable housing, and an image sensor mount coupled to the tiltable housing. A pannable housing shell and a tiltable housing shell combine to form an enclosure for one of more of the pan drive and the tilt drive. In some embodiments, the pannable housing includes an arm on only one side of the tiltable housing. The arm supports the tiltable housing shell and allows the tiltable housing shell to tilt up and down.

In an embodiment, an image sensor mount includes a base, a pannable housing coupled to the base, a tiltable housing coupled to the pannable housing, a pan drive that rotates the pannable housing, a tilt drive that rotates the tiltable housing, and an image sensor mount coupled to the tiltable housing. The tiltable housing couples to the pannable housing on one side of the image sensor mount by way of a circumferential bearing. The circumferential bearing allows the tiltable housing to rotate relative to the pannable housing.

In an embodiment, an image sensor mount includes a base, a pannable housing coupled to the base, a tiltable housing coupled to the pannable housing, a pan drive that rotates the pannable housing, a tilt drive that rotates the tiltable housing, and an image sensor mount coupled to the tiltable housing. The pan drive, the tilt drive, or both include a helical drive gear and a helical driven gear. The helical drive gear is configured to drive the helical driven gear to rotate one or both of the housings.

In an embodiment, a method of positioning an image sensor includes operating a motor to drive a first helical gear to rotate a pannable housing to a desired pan angle, and operating a motor to drive a second helical gear to rotate a tiltable housing to a desired tilt angle.

Rotating the pannable housing to the desired pan angle and rotating the tiltable housing the desired tilt angle points the image sensor in a desired direction.

### BRIEF DESCRIPTION OF THE DRAWINGS

FIG. 1 illustrates one embodiment of a mount for an image sensor.

FIG. 2 illustrates a front view of an embodiment of an image sensor mount.

FIG. 3 is a cross sectional view illustrating an embodiment of an image sensor mount.

FIG. 4 illustrates an embodiment of a mount system with a circumferential bearing between a pannable housing and a tiltable housing.

FIG. 5 illustrates an embodiment of mount system having a pan drive with an idler gear.

FIG. 6 illustrates an embodiment of controlling image sensor position with helical gears.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

As used herein, “base” includes any element or combination of elements that holds or supports another element or elements.

As used herein, an element or device is “circumferential” if it surrounds one or more elements (for example, forms a ring around another element) or lies at or around an edge or circumference (for example, along the edge of an enclosure or housing).

As used herein, “coupled to” includes a direct connection or an indirect connection. Elements may be coupled to one another in any of various manners, including a fixed connection, pivoting connection, sliding connections, or combinations thereof.

As used herein, “drive” means any device or system that can move, rotate, translate, or position an element or combination of elements. A drive may include one or more of any of various drive elements, such as gears, rollers, wheels, armatures, rods, or sprockets.

As used herein, “image” includes still images and moving images. In some embodiments, an image includes video.

As used herein, an “image sensor” means any device that can acquire or capture an image of an object or objects, such as a camera.

In some embodiments, a support system for a tilting video sensor includes a cantilevered support for a tilting sensor chassis. The support may include a circumferential base with an arm protruding downwardly from one side. The tilting sensor chassis may be mounted to the arm.

In some embodiments, a fully machined metal shell piece serves as both support for parts of a camera system and an exoskeleton for the parts to resist water, dust, and other contaminants. In one embodiment, housing shells are aluminum.

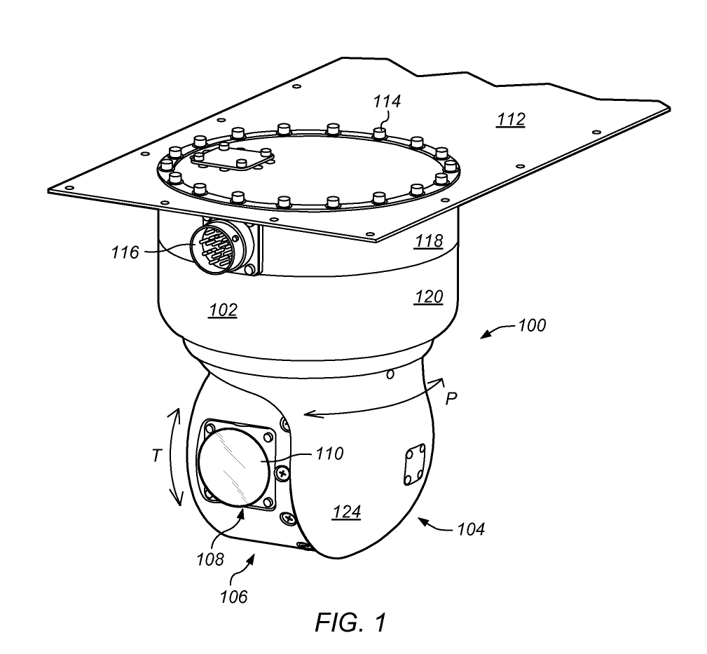

FIG. 1 illustrates one embodiment of a mount for an image sensor. Mount system 100 includes base 102, pannable assembly 104, tiltable assembly 106, and image sensor mounting receptacle 108. Image sensor 110 is installed in image sensor mounting receptacle 108. Base 102 is attached to mounting plate 112 by way of fasteners 114. System mounting plate 112 may be included in, or secured to, a structural element of the system to which mount system 100 is attached. The system may be a fixed or movable structure. In some embodiments, system mounting plate 112 is part of a vehicle. Electrical connector receptacle 116 is provided on base 102 for connecting components of mount system 100 to external systems.

In some embodiments, system mounting plate 112 is part of an aircraft. Examples of aircraft on which an image sensor may be installed include commercial airplanes, military airplanes, helicopters, and unmanned aerial vehicles (“UAVs”).

Base 102 includes upper housing 118 and lower housing 120. Pannable assembly 104 includes pannable housing 124. Tiltable assembly 106 includes tiltable housing 126. Pannable housing 124 may rotate relative to base 102 in a horizontal plane (for example, in the direction of arrows P). Tiltable housing 126 may rotate in a vertical plane on relative to pannable housing 124 (for example, in the direction of arrows T). The direction of image sensor 110 may be controlled by orienting pannable housing 124 relative to base 102 and tiltable housing 126 relative to pannable housing 124.

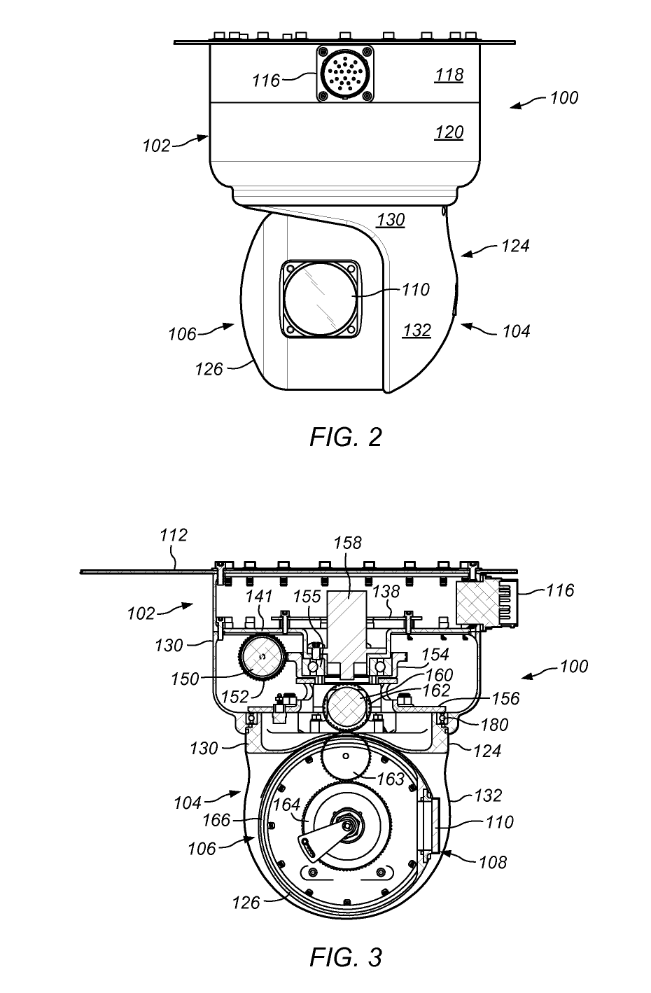

FIG. 2 illustrates a front view of an image sensor mount. Pannable housing 124 includes upper rim 130 and arm 132. Arm 132 descends from upper rim 130 on one side of tiltable housing 126. Tiltable housing 126 is coupled to arm 130. Arm 132 may be in a cantilevered relationship with respect to base 102. Tiltable housing 126 is supported by pannable housing 124 on only one side of tiltable housing 126 (in FIG. 2, the right side of the tiltable housing).

Tiltable housing 126 may be removable from pannable assembly 104. Any fasteners connecting tiltable assembly 126 to may be removed. Tiltable housing 126 may be withdrawn laterally (for example, to the left as shown in FIG. 2, away from arm 132 of pannable housing 124.)

FIG. 3 is a cross sectional view illustrating one embodiment of an image sensor mount. (In FIG. 3, gears are represented schematically for illustrative purposes). Mount system 100 includes base 102, pannable assembly 104, tiltable assembly 106, control circuit board 138, pan drive 140, and tilt drive 142. Base 102 includes upper housing 118, lower housing 120, and base plate 141.

Pan drive 140 includes pan drive motor 150, pan helical drive gear 152, and pan helical driven gear 154. Pan helical driven gear 154 is mounted for rotation relative to base plate 141 by way of bearing 155. Pan helical drive gear 152 is attached to pan drive motor 150. Pan helical drive gear 152 may engage pan helical driven gear 154. Pannable housing carrier 156 is attached to pan helical driven gear 154. Pan drive motor 150 may be operated to turn pannable housing carrier 156 by way of pan helical drive gear 152 and pan helical driven gear 154.

In certain embodiments, central drive motor 158 is coupled to pannable housing carrier 156. In this case, central drive motor 158 may be operated to control rotate pannable housing carrier 156.

Tilt drive 142 includes tilt drive motor 160, tilt helical drive gear 162, tilt idler gear 163, and tilt helical driven gear 164. Tilt helical drive gear 162 is attached to tilt drive motor 160. Tilt helical drive gear 162 may engage tilt helical idler gear 163. Tilt helical idler gear 163 engages tilt helical driven gear 164. Tiltable housing carrier 166 is attached to tilt helical driven gear 164. Tilt drive motor 160 may be operated to turn tilt housing carrier 166 by way of tilt helical drive gear 162, tilt helical idler gear 163, and tilt helical driven gear 164.

In some embodiments, gears in pan drive 140 and tilt drive 142 are helical gears. The teeth of each of the helical gears teeth may be at a 45 degree angle relative to the axis of rotation of the gear. In some embodiments, adjacent gears are engaged with one with the rotation axes of the two gears parallel to one another. In some embodiments, adjacent gears are engaged with one with the rotation axes of the two gears perpendicular to one another. In some embodiments, the gears in an image sensor mount are of types other than helical gears. Examples of other types of gears that may be used in some embodiments include straight gears, worm gears, bevel gears, and crown gears.

Control circuit board 138 may include electrical and electronic components for operating ad camera or a positioning mechanism for a camera. Control circuit board 138 may be connected to drive motors in mount system 100, such as pan drive motor 150, central drive motor 158, and tilt drive motor 160. Control circuit board 138 may include control circuits for operating and/or acquiring data from image sensor 110. Power for pan drive motor 150, central drive motor 158, and tilt drive motor 160, and image sensor 110 may be supplied through electrical conductors via connector 116 and control circuit board 138.

Upper housing 118 of base 102, lower housing 120 of base 102, pannable housing 124, and tiltable housing 126 may protect components inside the housing, such as gears, motors, bearings, and electronic from contamination, ice, moisture, or other conditions that might impair the operation of the mount system. In some embodiments, each of base housing 140, pannable housing 124, and tiltable housing 126 is a machined shell. In one embodiment, pannable housing 124 and tiltable housing 126 combine to form an enclosure for elements of pan drive 140 and tilt drive 142. In some embodiments, seals are provided between housing elements (for example, between pannable housing 124 and tiltable housing 126. Seals may inhibit leakage of contaminants into the interior of the mount system enclosure. In some embodiments, seals are dynamic o-ring seals. Any of various elastomeric materials, or other suitable seal materials, may be used for o-ring seals.

In some embodiments, connections between housing elements of a mount system include circumferential bearings. Circumferential bearings may be in the form a ring near the outer edge of a section of a housing. The circumferential bearing may surround elements of the mount system, such as drive gears, motors, and image sensors. As an example, mount system 100 includes pan bearing 180. Pan bearing 180 may be in the form of a ring bearing that extends around the edge of pan housing 124.

In some embodiments, a pan-tilt system includes a circumferential bearing mounts. In an embodiment, a first circumferential bearing is used to mount a panning mechanism on a host structure (such as an aircraft fuselage), and a second circumferential bearing is used to mount a tilt chassis for a video sensor on the panning mechanism.

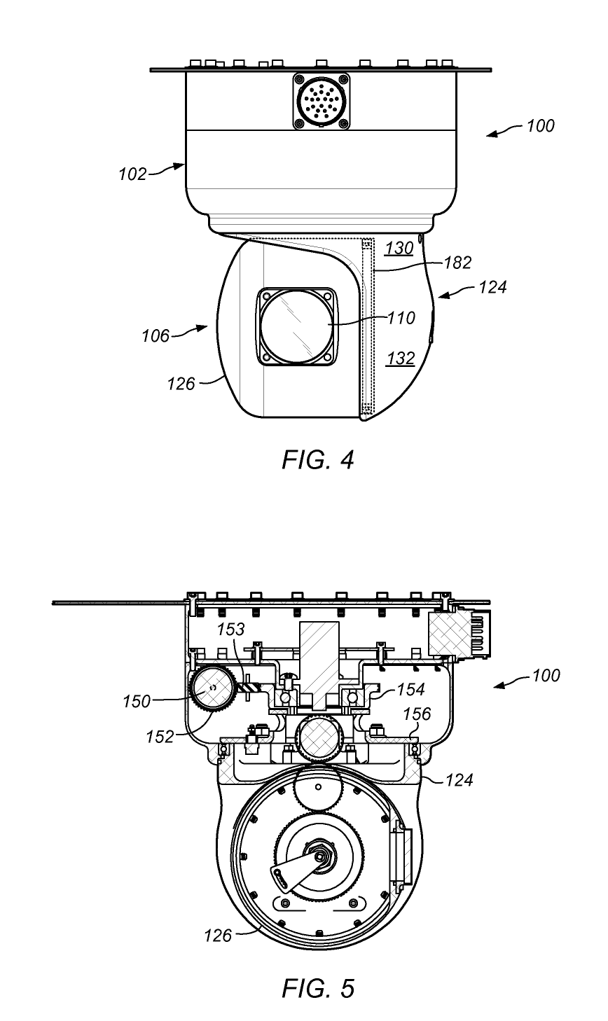

FIG. 4 illustrates one embodiment of a mount system with a circumferential bearing between a pannable housing and a tiltable housing. Mount system 100 includes tilt bearing 182. Tilt bearing 182 may be in the form of a ring bearing that extends around the edge of tilt housing 126.

In some embodiments, a gear drive mechanism for pan rotation and tilt rotation uses 45 degree helical tooth gears. The helical tooth gears may be selectably arrangeable to allow for either perpendicular or parallel gear connections. Some embodiments use multiple gears in a horizontal-vertical arrangement or a horizontal-horizontal arrangement. In some embodiments, the drive mechanism includes one or more idler gears.

In some embodiments, a pan drive includes one or more idler gears. FIG. 5 illustrates an embodiment of mount system having a pan drive with an idler gear. Pan drive 140 includes pan drive motor 150, pan helical drive gear 152, pan idler gear 153, and pan helical driven gear 154. Pan helical drive gear 152 is attached to pan drive motor 150. Pan helical drive gear 152 may engage pan helical idler gear 153. Pan helical idler gear 153 engages pan helical driven gear 154. Pan housing carrier 156 is attached to pan helical driven gear 154. Pan drive motor 150 may be operated to turn pan housing carrier 156 by way of pan helical drive gear 152, pan helical idler gear 153, and pan helical driven gear 154.

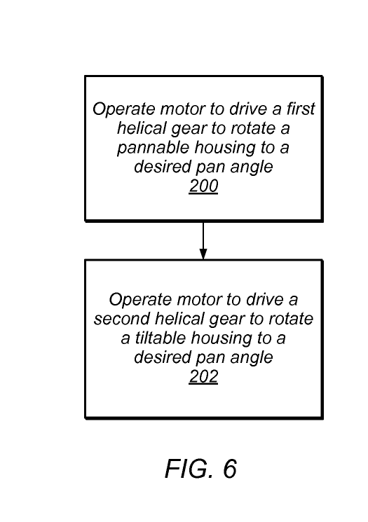

FIG. 6 illustrates one embodiment of controlling image sensor position with helical gears. At 200, a first motor is operated to drive a first helical gear to rotate a pannable housing to a desired pan angle. In some embodiments, the motor is controlled in response to a signal received from an external controller.

At 202, a second motor is operated to drive a second helical gear to rotate a tiltable housing to a desired tilt angle. In some embodiments, the motor is controlled in response to a signal received from an external controller. Rotating pannable housing to the desired pan angle and rotating the tiltable housing to the desired tilt angle may point the image sensor in a desired direction.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of the invention. Methods may be implemented manually, in software, in hardware, or a combination thereof. The order of any method may be changed, and various elements may be added, reordered, combined, omitted, modified, etc. Changes may be made in the elements described herein without departing from the spirit and scope of the invention as described in the following claims.

1. A image sensor mount, comprising:
a base;
a pannable housing coupled to the base, wherein the pannable housing comprises a pannable housing shell configured to rotate with respect to the base;
a tiltable housing coupled to the pannable housing, wherein the tiltable housing comprises a tiltable housing shell configured to rotate with respect to the pannable housing;
a pan drive configured rotate the pannable housing with respect to base;
a tilt drive configured to rotate the tiltable housing with respect to the pannable housing; and
an image sensor mount coupled to the tiltable housing, wherein the image sensor mount is configured to hold an image sensor,
wherein the pannable housing shell and the tiltable housing shell combine to form an enclosure for one of more of the pan drive and the tilt drive.

2. The image sensor mount of claim 1, wherein the pannable housing comprises an arm on one side the tiltable housing, wherein the arm is rotatably coupled to the tiltable housing.

3. The image sensor mount of claim 1, wherein the base comprises a base housing, wherein the base housing encloses at least one of the pan drive and the tilt drive.

4. The image sensor mount of claim 1,
wherein the tiltable housing couples to the pannable housing is coupled to the base by way of a first circumferential bearing, wherein the first circumferential bearing allows the pannable housing to rotate relative to the base; and
wherein the tiltable housing couples to the pannable housing by way of a second circumferential bearing, wherein the second circumferential bearing allows the tiltable housing to rotate relative to the pannable housing.

5. The image sensor mount of claim 1, wherein the base is configured to mount on a body of an aircraft.

6. The image sensor mount of claim 1, wherein at least one of the pan drive and the tilt drive comprises a helical drive gear and a helical driven gear, wherein the helical drive gear is configured to drive the helical driven gear.

7. The image sensor mount of claim 1, further comprising at least one idler gear between the helical drive gear and the helical driven gear.

8. The image sensor mount of claim 1, wherein the pan drive comprises a helical drive gear coupled to the base and a helical driven gear coupled to the pannable housing.

9. The image sensor mount of claim 8, wherein the helical drive gear of the pan drive has a vertical axis of rotation and the helical driven gear has a vertical axis of rotation.

10. The image sensor mount of claim 9, wherein the helical drive gear of the pan drive has a vertical axis of rotation and the helical driven gear has a horizontal axis of rotation.

11. The image sensor mount of claim 1, wherein the tilt drive comprises a helical drive gear coupled to the base and a helical driven gear coupled to the tiltable housing.

12. The image sensor mount of claim 1, wherein the helical drive gear of the tilt drive has a vertical axis of rotation and the helical driven gear has a vertical axis of rotation.

13. The image sensor mount of claim 1, wherein the helical drive gear of the tilt drive has a horizontal axis of rotation and the helical driven gear has a vertical axis of rotation.

14. A image sensor mount, comprising:
a base;
a pannable housing coupled to the base, wherein the pannable housing is configured to rotate with respect to the base;
a tiltable housing coupled to the pannable housing, wherein the tiltable housing is configured to rotate with respect to the pannable housing;
a pan drive configured rotate the pannable housing with respect to base;
a tilt drive configured to rotate the tiltable housing with respect to the pannable housing; and
an image sensor mount coupled to the tiltable housing, wherein the image sensor mount is configured to hold an image sensor,
wherein the tiltable housing couples to the pannable housing on at least one side of the image sensor mount by way of a circumferential bearing, wherein the circumferential bearing allows the tiltable housing to rotate relative to the pannable housing.

15. The image sensor mount of claim 14, wherein at least one of the pannable housing encloses at least one of the pan drive and the tilt drive.

16. The image sensor mount of claim 14, wherein the pannable housing comprises a pannable housing shell and the tiltable housing comprises a tiltable housing shell, wherein the pannable housing shell and the tiltable housing shell combine to form an enclosure for one of more of the drives.

17. The image sensor mount of claim 14, wherein the pannable housing comprises an arm on one side the tiltable housing, wherein the arm is rotatably coupled to the tiltable housing.

18. (canceled)

19. The image sensor mount of claim 14, wherein the pannable housing couples to the base by way of a circumferential bearing, wherein the circumferential bearing allows the pannable housing to rotate relative to the base.

20-28. (canceled)

29. A image sensor mount, comprising:
a base;
a pannable housing coupled to the base, wherein the pannable housing is configured to rotate with respect to the base;
a tiltable housing coupled to the pannable housing, wherein the tiltable housing is configured to rotate with respect to the pannable housing;
a pan drive configured rotate the pannable housing with respect to base;
a tilt drive configured to rotate the tiltable housing with respect to the pannable housing; and
an image sensor mount coupled to the tiltable housing, wherein the image sensor mount is configured to hold an image sensor,
wherein at least one of the pan drive and the tilt drive comprises a helical drive gear and a helical driven gear, wherein the helical drive gear is configured to drive the helical driven gear to rotate one or both of the housings.

30. The image sensor mount of claim 29, wherein the helical drive gear is coupled to the base, wherein the helical driven gear is coupled to the pannable housing, wherein the helical drive gear is operable to rotate the pannable housing.

31-43. (canceled)
